(19) United States
(12) Patent Application Publication
(10) Pub. No.: US 2021/0099540 A1
(43) Pub. Date: Apr. 1, 2021

(54) Automatic Account Update After a Security Event

(71) Applicant: Visa International Service Association, San Francisco, CA (US)

(72) Inventor: Kelvan Patrick Howard, San Francisco, CA (US)

(21) Appl. No.: 16/589,551

(22) Filed: Oct. 1, 2019

(51) Int. Cl. H04L 29/08

(52) U.S. Cl. CPC H04L 67/306; H04L 63/0861

(57) ABSTRACT

The present disclosure is directed to a computer-implemented method, hardware storage device, and system that include a rapid and efficient manner to communicate to a service provider the occurrence of an event that may affect the user's relationship with the service provider, and, in response to communication of the event to the service provider, update at least one feature of a user account associated with the service provider.

### BACKGROUND

### 1. Technical Field

The present disclosure relates to systems, methods, techniques, instruction sequences, and computer program products associated with and configured to the technical field of special purpose machines that facilitate generation and provision of application program interfaces (or APIs), including APIs that communicate messages to service providers to update features associated with a user account in response to a security event or a change in the user's status.

### 2. Technical Considerations

For many users of services provided by service providers, any changes in the user or user's account status requires a phone call or email to the service provider to update information associated with their accounts. In many instances, contacting a service provider utilizing a phone call or an email is time-consuming or cumbersome. If a user is out of the country or attending an event with a large number of attendees, a phone call may be undesirable due to the costs or the level of background noise. Utilizing an email may also be difficult in areas without sufficient light to type a message or in matters of urgency. Text messages may be too brief to communicate the scope of the event meriting the user request and may also be time-consuming. Chatbots that require machine language processing may misunderstand the scenario and may not be programmed to handle all of the scenarios that a consumer may need to report. In matters associated with a security event or where responding quickly is critical, the time required to complete a phone call, email, or text may increase the risk associated with the event.

Therefore, there is a need in the art for an improved way to quickly, safely, and efficiently communicate to a service provider the occurrence of a security event or a change in the user's status.

### SUMMARY

In some non-limiting embodiments or aspects, the present disclosure is directed to a computer-implemented method, computer program product, and system that include a rapid and efficient manner to communicate (by a computing system utilizing special purpose processors) to a service provider the occurrence of an event that may affect the user's relationship with the service provider, and, in response to communication of the event to the service provider, update at least one feature of a user account associated with the service provider. According to some non-limiting embodiments or aspects, provided are a computer implemented method, system, and computer program product for automatically updating at least one feature of a user account in response to user input noting the occurrence of a security event. In some non-limiting embodiments or aspects, the modified user account features may include changing or canceling the status of a user account (including cancelling the account, or adding or removing a temporary hold on the account), assigning a new identifier or a new password to the account, modifying the geographic location or address associated with the account, or, in the cases where the account is associated with a bank or financial account, confirming or denying a transaction associated with the user account.

According to some non-limiting embodiments or aspects, provided is a computer-implemented method for automatically updating at least one feature of a user account in response to a security event, the method comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

In some non-limiting embodiments or aspects, in response to receiving the user reply to the at least one notification comprising denial of the request to update at least one feature associated with the at least one user account, the computer-implemented method automatically stores the user reply and information associated with the event.

In some non-limiting embodiments or aspects, the user reply to the at least one notification comprises at least one of the following: a biometric parameter, a password, a passcode, multi-factor authentication, or any combination thereof.

In some non-limiting embodiments or aspects, updating at least one feature associated with at least one user account comprises canceling the at least one user account.

In some non-limiting embodiments or aspects, updating at least one feature associated with at least one user account comprises assigning a new account identifier to the at least one user account.

In some non-limiting embodiments or aspects, updating at least one feature associated with at least one user account comprises adding or removing a temporary account hold.

In some non-limiting embodiments or aspects, updating at least one feature associated with at least one user account comprises confirming or denying the authenticity of a transaction conducted using the at least one user account.

Additionally, according to some non-limiting embodiments or aspects, provided is a computer program product storing instructions that, when executed by one or more processors, cause the one or more processors to perform operations comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

In some non-limiting embodiments or aspects, in response to receiving the user reply to the at least one notification comprising denial of the request to update at least one feature associated with the at least one user account, the computer program product automatically stores the user reply and information associated with the event.

In some non-limiting embodiments or aspects, the user reply to the notification comprises at least one of the following: a biometric parameter, a password, a passcode, multi-factor authentication, or any combination thereof.

In some non-limiting embodiments or aspects, updating at least one feature associated with at least one user account comprises canceling the at least one user account.

In some non-limiting embodiments or aspects, updating at least one feature associated with at least one user account comprises assigning a new account identifier to the at least one user account.

In some non-limiting embodiments or aspects, updating at least one feature associated with at least one user account comprises adding or removing a temporary account hold.

In some non-limiting embodiments or aspects, updating at least one feature associated with at least one user account comprises confirming or denying the authenticity of a transaction conducted using the at least one user account.

According to some non-limiting embodiments or aspects, provided is a system, comprising one or more hardware processors, and a storage device storing instructions that, when executed by the one or more hardware processors, causes the one or more hardware processors to perform operations comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

In some non-limiting embodiments or aspects, in response to receiving the user reply to the at least one notification comprising denial of the request to update at least one feature associated with the at least one user account, the system automatically stores the user reply and information associated with the event.

In some non-limiting embodiments or aspects, the user reply to the at least one notification comprises at least one of the following: a biometric parameter, a password, a passcode, multi-factor authentication, or any combination thereof.

In some non-limiting embodiments or aspects, updating at least one feature associated with at least one user account comprises canceling the at least one user account.

In some non-limiting embodiments or aspects, updating at least one feature associated with at least one user account comprises assigning a new account identifier to the at least one user account.

In some non-limiting embodiments or aspects, updating at least one feature associated with at least one user account comprises adding or removing a temporary account hold.

In some non-limiting embodiments or aspects, updating at least one feature associated with at least one user account comprises confirming or denying the authenticity of a transaction conducted using the at least one user account.

Further non-limiting embodiments or aspects are set forth in the following numbered clauses:

Clause 1. A computer-implemented method for automatically updating at least one feature of a user account in response to a security event, the method comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

Clause 2. The computer-implemented method of Clause 1, wherein, in response to receiving the user reply to the at least one notification comprising denial of the request to update at least one feature associated with the at least one user account, automatically storing the user reply and information associated with the event.

Clause 3. The computer-implemented method of Clause 1 or 2, wherein the user reply to the at least one notification comprises at least one of the following: a biometric parameter, a password, a passcode, multi-factor authentication, or any combination thereof.

Clause 4. The computer-implemented method of any of Clauses 1-3, wherein updating at least one feature associated with at least one user account comprises canceling the at least one user account.

Clause 5. The computer-implemented method of any of Clauses 1-4, wherein updating at least one feature associated with at least one user account comprises assigning a new account identifier to the at least one user account.

Clause 6. The computer-implemented method of any of Clauses 1-5, wherein updating at least one feature associated with at least one user account comprises adding or removing a temporary account hold.

Clause 7. The computer-implemented method of any of Clauses 1-6, wherein updating at least one feature associated with at least one user account comprises confirming or denying the authenticity of a transaction conducted using the at least one user account.

Clause 8. A computer program product for automatically updating at least one consumer account in response to a security event, the computer program product storing instructions that, when executed by one or more processors, cause the one or more processors to perform operations comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

Clause 9. The computer program product of Clause 8, wherein, in response to receiving the user reply to the at least one notification comprising denial of the request to update at least one feature associated with the at least one user account, automatically storing the user reply and information associated with the event.

Clause 10. The computer program product of Clause 8 or 9, wherein the user reply to the at least one notification comprises at least one of the following: a biometric parameter, a password, a passcode, multi-factor authentication, or any combination thereof.

Clause 11. The computer program product of any of Clauses 8-10, wherein updating at least one feature associated with at least one user account comprises canceling the at least one user account.

Clause 12. The computer program product of any of Clauses 8-11, wherein updating at least one feature associated with at least one user account comprises assigning a new account identifier to the at least one user account.

Clause 13. The computer program product of any of Clauses 8-12, wherein updating at least one feature associated with at least one user account comprises adding or removing a temporary account hold.

Clause 14. The computer program product of any of Clauses 8-13, wherein updating at least one feature associated with at least one user account comprises confirming or denying the authenticity of a transaction conducted using the at least one user account.

Clause 15. A system comprising: one or more hardware processors; and a storage device storing instructions that, when executed by the one or more hardware processors, causes the one or more hardware processors to perform operations comprising: receiving, with at least one processor, input from a user of at least one user resource, the input indicating the occurrence of an event; generating and communicating utilizing a graphical user interface, with at least one processor, at least one notification to the user, the at least one notification comprising at least one option associated with the event; receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user; in response to receiving the user reply to the at least one notification comprising confirmation of the request to update at least one feature associated with the at least one user account, automatically constructing, with at least one processor, at least one application program interface (API) request comprising the user reply and information associated with the event; transmitting, with at least one processor, the API request to the server of a service provider; and, in response to the transmitting, receiving at the at least one user resource, with at least one processor, at least one message from the server of the service provider, the at least one message comprising confirmation that the at least one feature associated with the at least one user account has been updated.

Clause 16. The system of Clause 15, wherein, in response to receiving the user reply to the at least one notification comprising denial of the request to update at least one feature associated with the at least one user account, automatically storing the user reply and information associated with the event.

Clause 17. The system of Clauses 15 or 16, wherein the user reply to the at least one notification comprises at least one of the following: a biometric parameter, a password, a passcode, multi-factor authentication, or any combination thereof.

Clause 18. The system of any of Clauses 15-17, wherein updating at least one feature associated with at least one user account comprises canceling the at least one user account.

Clause 19. The system of any of Clauses 15-18, wherein updating at least one feature associated with at least one user account comprises assigning a new account identifier to the at least one user account.

Clause 20. The system of any of Clauses 15-19, wherein updating at least one feature associated with at least one user account comprises adding or removing a temporary account hold.

Clause 21. The system of any of Clauses 15-20, wherein updating at least one feature associated with at least one user account comprises confirming or denying the authenticity of a transaction conducted using the at least one user account.

### BRIEF DESCRIPTION OF THE DRAWINGS

The above and other aspects, features, and advantages of the present disclosure are illustrated by way of example and not limitation in the following detailed description taken in conjunction with the accompanying drawing.

FIG. 1. is a diagram of a non-limiting embodiment or aspect of an environment that illustrates a digital communication network comprising a user resource and a service provider server. The environment allows communication from a user of the user resource to the service provider server to update at least one account feature according to some non-limiting embodiments or aspects.

### DETAILED DESCRIPTION

Hereinafter, embodiments of the present disclosure will be described with reference to the accompanying drawings; however, it should be understood that there is no intent to limit the present disclosure to the particular forms or examples disclosed herein. The specific details set forth are illustrative only and provide an understanding of various examples of the present subject matter. The present disclosure should be construed to cover various modifications, equivalents, and/or alternatives of the present disclosure's examples with the examples merely typifying possible variations. Unless explicitly stated otherwise, the structural elements described in the present disclosure are optional and may be combined or subdivided, and operations may vary in sequence or be combined or subdivided.

### Definitions

As used herein, the expressions “comprise”, “may comprise”, “have”, “may have”, “include”, and “may include” refer to the existence of a corresponding feature, such as a numeral, function, operation, or constituent element (such as a component) and do not exclude one or more additional features.

The “user resource”, according to the examples of the present disclosure, may include at least one of, for example, a mobile device, a smart phone, a feature phone, a tablet personal computer, a video phone, an electronic book (e-book) reader, a desktop PC, a laptop PC, a netbook computer, a workstation, a server, a personal digital assistant (PDA), a portable multi-media player, a wearable device, a smart watch, a connected ring, a connected bracelet, connected glasses, connected contact lenses, a virtual reality device, head-mounted device, a fabric integrated with an electronic chip or internet connectivity, a mobile medical device or some type of biophysical modification such as connected tattoo or bio-implant. According to some examples, the user resource may be a connected home appliance or a connected vehicle. The connected home appliance may include at least one of a television, a digital home assistant, a refrigerator, a vacuum cleaner, a microwave oven, a set-top box, a gaming console, or an electronic key. According to some examples, the user resource may include connected furniture or a connected building/structure. The user resource is not limited to the aforementioned devices and may include a future device according the development of technology.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “account identifier” may refer to one or more types of identifiers associated with a user account (e.g., an account identifier, a primary account number (PAN), a card number, a payment card number, a token, and/or the like). In some non-limiting embodiments or aspects, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payment transactions. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. In some non-limiting embodiments or aspects, the account identifier may be an original account identifier as chosen by or entered by a user at the creation of the account associated with the identifier (e.g., a username). For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “server” or “processor” may refer to one or more computing machines, such as processors, storage devices, and/or similar computer components that communicate with client devices and/or other computing machines over a network, such as the Internet or private networks, and, in some examples, facilitate communication among other servers and/or client devices. It will be appreciated that various other arrangements are possible. As used herein, the term “system” may refer to one or more computing machines or combinations of computing machines such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “computing machine” may refer to one or more computing devices or electronic devices that are configured to directly or indirectly communicate with or over one or more networks. The computing machine may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing machine may not be a mobile device, such as a desktop computer. Furthermore, the term “computer” may refer to any computing machine that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

Example systems, methods, techniques, computer program products, instruction sequences, and computing machine program products facilitate automatically determining user geolocation data to allow a user to authorize an update to a service provided by a service provider to the user. Example systems (e.g., special-purpose machines) are configured to access a user resource comprising a user's geolocation data that includes the user's geographic data and the user's calendar data. Some non-limiting embodiments or aspects provide mechaniSMS and logic that are capable of accessing the location services of a user resource to determine a user's geographic data as a function of time.

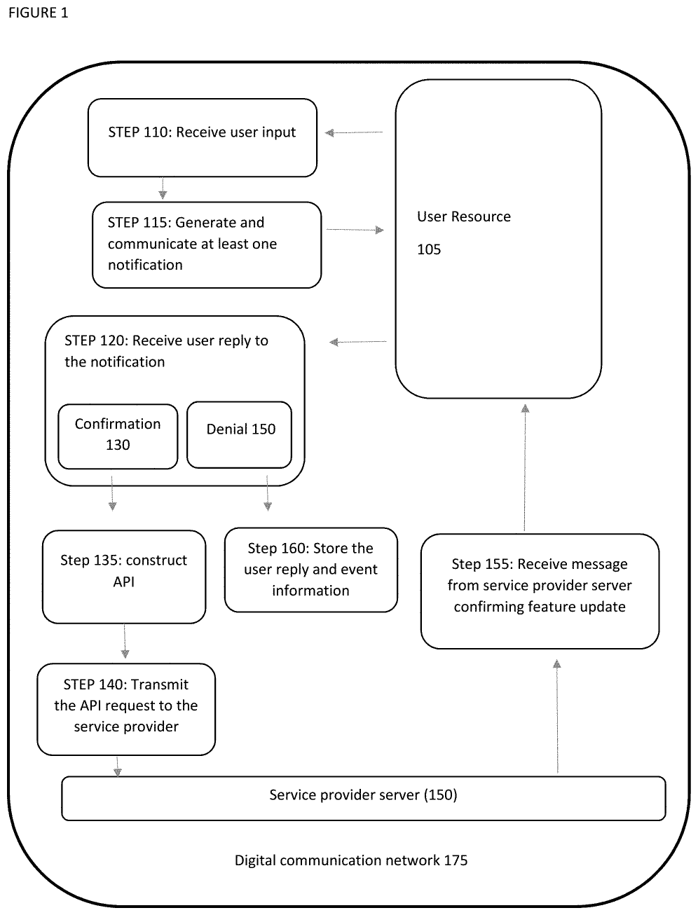

In some non-limiting embodiments or aspects, and as shown in FIG. 1, a user associated with a user resource 105 provides (utilizing at least one processor) to the user resource 105 input indicating the occurrence of an event (Step 110). In some non-limiting embodiments or aspects, the user resource 105 may have been associated with a user or a group of users by linking the user resource device ID to an account identifier associated with a particular user or group of users. Additionally, in some non-limiting embodiments or aspects, the user resource 105 may have been associated with a user or a group of users by downloading internet cookies to the user resource 105 after the user or users of the user resource 105 accessed an internet service, web page, web link, or other suitable service provided by a service provider associated with a user account characterized by an account identifier. Additionally, in further non-limiting embodiments or aspects, the user resource 105 may have been associated with a specific user or a group of users by placing a token associated with the user resource device ID and account identifier on the user resource 105. In some non-limiting embodiments or aspects, the user resource 105 may be associated with a user or group of users by sending a communication from the user resource to a server of the service provider. In some non-limiting embodiments or aspects, the communication may take the form of a text, SMS, iMessage, email, or a phone call. In some non-limiting embodiments or aspects, the communication may be constructed such that it comprises information associated with the user, a group of users, or an account identifier identifying the user or group of users. In a further, non-limiting embodiment or aspect, the identification information comprising the communication may be embedded or encrypted information. In an additional non-limiting embodiment or aspect, the communication associating the user resource 105 with the user may be sent from a digital wallet comprising a digital representation of the user account. The user resource 105 may be associated with a user in any suitable method that allows the user, user resource 105, or a service provider to identify an account identifier associated with the user.

In some non-limiting embodiments or aspects, the user input to the user resource 105 indicating the occurrence of an event, may include options regarding the nature of the event. In some non-limiting embodiments or aspects, the user input may include selecting an option detailing a class of event or inputting details noting the nature of the event. In some non-limiting embodiments or aspects, the input may be configured such that it allows the user to type information associated with the event, select the relevant event from the list by clicking on the event, touch the event on a user-resource with a touch screen, scroll through a list of event such that the desired selection is highlighted, swipe on the selected event, press an alphanumeric character associated with the selected event, say aloud the event or an alphanumeric character associated with the event, utilize iris-tracking, utilizing gestures, or utilize any appropriate manner of inputting information associated with the nature of the event.

In some non-limiting embodiments or aspects related to a financial network, the event may include a consumer losing or damaging their portable financial instrument. In some non-limiting embodiments or aspects, the event may comprise the scenario where a thief robs a consumer and absconds with their portable financial instrument. In further non-limiting embodiments or aspects, the event may be a transaction denial due to a change in consumer location or a service provider's perceived threat of fraud. In further non-limiting embodiments or aspects, the event may relate to delivery services, digital content providers, delivery services, or any other service that may experience an event affecting the quality of the service, a disruption in service, or a compromised consumer account.

In some non-limiting embodiments or aspects, at least one notification comprising at least one option associated with the event is generated and communicated, with at least one processor, in response to receipt of the user input (Step 115). The at least one notification may comprise an email, text message, SMS, IMS, on-screen message, phone call, or any suitable form of notifying the user that the input regarding the event occurrence was received. In some non-limiting embodiments or aspects, the options associated with the event are dynamically determined based on the event. In some non-limiting embodiments or aspects where the user provides input via a graphical user interface (or GUI), the GUI may contain a list of events allowing the user to see the event that is most relevant for the event which has occurred. In some non-limiting embodiments or aspects, the listed events may include any or all of the following:
reporting lost or damaged card
reporting stolen card
reporting a transaction denial
confirming a transaction
creating a new account associated with the user account
notify the service provider of a change in the user location
updating the user account address
updating the delivery address
postponing delivery
canceling delivery
temporarily disabling content delivery
enabling content delivering
placing a hold on the account

In some non-limiting embodiments or aspects, the events may be shown in cascading menus that successively display details or options associated with classes of events. In some non-limiting embodiments or aspects, the user input indicating the occurrence of an event may include broad categories of events. In some non-limiting embodiments or aspects, the notification may include the following subsets or categories:
card related
delivery related
streaming content related

In some non-limiting embodiments or aspects, in response to the notification, the user may select a category and be presented with a sub-list of events associated with a category. For example, in one non-limiting aspect or embodiment, the sub-list associated with the “card related” category may include the following options:
report lost or damaged card
report stolen card
report a transaction denial
confirm a transaction
create a new account associated with the user account
update the user account address

As shown in FIG. 1, in Step 120, the user may reply to the at least one notification by utilizing the user resource. In some non-limiting embodiments or aspects, a user may select the relevant event from the list by clicking on the event, touching the event on a user-resource with a touch screen, scrolling through a list of event such that the desired selection is highlighted, swiping on the selected event, pressing an alphanumeric character associated with the selected event, saying aloud the event or an alphanumeric character associated with the event, utilizing iris-tracking, or any appropriate manner of indicating a selected event included in a list of events. In one non-limiting event or aspect, a curated list or the full list of events may be displayed via a web page or a notification that appears on the screen of a user resource.

In some non-limiting embodiments or aspects, the user reply to the at least one notification (provided in Step 120) comprises (i) confirmation (130) of a request to update at least one feature associated with at least one user account or (ii) denial (150) of the request to update the at least one feature associated with the at least one user account.

In some non-limiting embodiments or aspects, the at least one feature associated with at least one user account may include the account status, account identifier, account address, a user privacy setting, a user delivery request, a delivery address, or any other account feature which may be affected by an event informing the account status or a user's ability to access the user account.

In some non-limiting embodiments or aspects which encompasses the case of a stolen credit card, the feature may comprise the account status and the confirmation to update at least one feature associated with the at least one user account may comprise a request to cancel a current account identifier and/or generate a new account identifier. In some non-limiting embodiments or aspects which encompasses the case of a declined portable financial device transaction, the feature may comprise the account status and the confirmation to update at least one feature associated with the at least one user account may comprise a request to confirm the transaction as being valid and/or to remove the temporary account hold automatically put in place by the service provider after the declined transaction. In some non-limiting embodiments or aspects which encompasses the case of an event disrupting delivery of a good by a delivery service, the feature may comprise the delivery address associated with the user account and the confirmation to update at least one feature associated with the at least one user account may comprise a request to change the delivery address from a primary address to a secondary address.

In some non-limiting embodiments or aspects, the user is able to update a feature of a single user account or multiple accounts associated with the same service provider or with different service providers.

In some non-limiting embodiments or aspects where the user reply comprises confirmation (130) of a request to update at least one feature, the confirmation may be configured as a biometric input, passcode, password, a verbal command, a gesture, a specified interaction with the user resource 105, or a multi-factor authentication that requires more than one type of user action.

In some non-limiting embodiments or aspects where the user reply comprises confirmation (130) of a request to update at least one feature, at least one application program interface (or API) comprising the user reply and information associated with the event (based on the user input noting the occurrence of the event) is constructed (Step 135) and transmitted (Step 140) to a server 150 of a service provider associated with the feature that the user would like to update.

In some non-limiting embodiments or aspects, the information associated with the event may comprise the nature of the event, the time of the event, the date of the event, and/or the location of the event.

In some non-limiting embodiments or aspects, the user resource 105 may transmit the API requests or share the constructed API requests with at least one other user resource (in this exemplary embodiment, a second user resource) associated with the same user, such that the at least one other user resource may transmit the API request to the service provider server 150. For example, the user resource 105 may comprise a user's smart watch, which may not have full internet connectivity, but may be tethered, using Bluetooth® or Wi-Fi®, to a user's connected user resource (e.g., a mobile phone). In the instant example, the user's smart watch may construct, using one or more processors, the at least one API request and then share the request with the user's mobile phone via their shared connection such that the user's mobile phone is configured to transmit the at least one API request to the service provider server 150 via a digital communication network 175.

In some non-limiting embodiments or aspects where the user reply comprises confirmation (130) of the request to update at least one feature, in response to transmitting the API request to the server of the service provider, at least one message (comprising confirmation that the at least one feature associated with at least one user account has been updated) is received in Step 155.

In some non-limiting embodiments or aspects, confirmation of the updated feature is shared with the user via the user resource 105. In some non-limiting embodiments or aspects, confirmation of the feature update may be shared with at least one additional user resource associated with the same user or transmitted to the user via a previously-selected preferred means of communication. For example, in one non-limiting embodiment, if a user provided the initial input indicating an event occurred on a connected watch, the update confirmation may be displayed on a mobile device or tablet associated with the user who initially provided input via the connected watch. In yet some non-limiting embodiments or aspects, the update confirmation may be sent to the user's account with the service provider or emailed to a previously selected email address. In yet some non-limiting embodiments or aspects, the confirmation may be stored by the service provider as a record of the user request to update a feature associated with a user account.

In some non-limiting embodiments or aspects where the user reply comprises denial (150) of the request to update at least one feature, the user reply to the notification and information associated with the event are stored (Step 160). In one non-limiting embodiment or application, the user reply to the notification and the information associated with the event are stored on the user resource 105. Alternatively, in a non-limiting embodiment or aspect, the user reply to the notification and the information associated with the event may be stored on the server of a service provider or on a cloud server associated with the manufacturer of the user resource, the user, a service provider, or any other party who might require access to the information.

In some non-limiting embodiments or aspects, storage (Step 160) of the user reply to the notification and information associated with the event allows user, user resource, or service provider to track the frequency of occurrence to improve the user experience.

The user has the ability to deny the request to update a feature in the cases where the event that necessitated the initial user input has been neutralized or was misunderstood or in cases where the user accidentally entered the initial input. For example, in the case where a user assumes they have lost their credit card, a user may choose to deny the request to update a feature associated with at least one of their accounts if they find the card before completing the required steps of the instant method, computer program, system, or apparatus.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific some non-limiting embodiments or aspects, various modifications and changes may be made to these embodiments without departing from the broader scope of embodiments of the present disclosure. For example, various embodiments or features thereof may be mixed and matched or made optional by a person of ordinary skill in the art. Such embodiments of the present subject matter may be referred to herein, individually or collectively, by the term “disclosure” merely for convenience and without intending to voluntarily limit the scope of this application to any single disclosure or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method for automatically updating at least one feature of a user account in response to a security event, the method comprising:
a. receiving, with at least one processor, input from a user of at least one user resource, the input indicating the occurrence of an event;
b. generating and communicating utilizing a graphical user interface, with at least one processor, at least one notification to the user, the at least one notification comprising at least one option associated with the event;
c. receiving, from the at least one user resource and with at least one processor, a user reply to the at least one notification, the user reply comprising; (i) confirmation of a request to update at least one feature associated with at least one user account associated with the user; or (ii) denial of the request to update at least one feature associated with at least one user account associated with the user;
d. in response to receiving the user reply to the at least one notification comprising confirmation of the request to update at least one feature associated with the at least one user account, automatically constructing, with at least one processor, at least one application program interface (API) request comprising the user reply and information associated with the event;
e. transmitting, with at least one processor, the API request to the server of a service provider; and
f. in response to the transmitting, receiving at the at least one user resource, with at least one processor, at least one message from the server of the service provider, the at least one message comprising confirmation that the at least one feature associated with the at least one user account has been updated.

2. The computer-implemented method of claim 1, wherein, in response to receiving the user reply to the at least one notification comprising denial of the request to update at least one feature associated with the at least one user account, automatically storing the user reply and information associated with the event.

3. The computer-implemented method of claim 1, wherein the user reply to the at least one notification comprises at least one of the following: a biometric parameter, a password, a passcode, multi-factor authentication, or any combination thereof.

4. The computer-implemented method of claim 1, wherein updating at least one feature associated with at least one user account comprises canceling the at least one user account.

5. The computer-implemented method of claim 1, wherein updating at least one feature associated with at least one user account comprises assigning a new account identifier to the at least one user account.

6. The computer-implemented method of claim 1, wherein updating at least one feature associated with at least one user account comprises adding or removing a temporary account hold.

7. The computer-implemented method of claim 1, wherein updating at least one feature associated with at least one user account comprises confirming or denying the authenticity of a transaction conducted using the at least one user account.

8. A computer program product for automatically updating at least one consumer account in response to a security event, the computer program product storing instructions that, when executed by one or more processors, cause the one or more processors to perform operations comprising:
a. receiving, with at least one processor, input from a user of at least one user resource, the input indicating the occurrence of an event;
b. generating and communicating, utilizing a graphical user interface, with at least one processor, at least one notification to the user, the at least one notification comprising at least one option associated with the event;
c. receiving, from the at least one user resource and user resource, a user reply to the at least one notification, the user reply comprising; (i) confirmation of a request to update at least one feature associated with at least one user account associated with the user; or (ii) denial of the request to update at least one feature associated with at least one user account associated with the user;
d. in response to receiving the user reply to the at least one notification comprising confirmation of the request to update at least one feature associated with the at least one user account, automatically constructing, with at least one processor, at least one application program interface (API) request comprising the user reply and information associated with the event;
e. transmitting, with at least one processor, the API request to the server of a service provider; and
f. in response to the transmitting, receiving, at the at least one user resource, with at least one processor, at least one message from the server of the service provider, the at least one message comprising confirmation that the at least one feature associated with the at least one user account has been updated.

9. The computer program product of claim 8, wherein, in response to receiving the user reply to the at least one notification comprising denial of the request to update at least one feature associated with the at least one user account, automatically storing the user reply and information associated with the event.

10. The computer program product of claim 8, wherein the user reply to the at least one notification comprises at least one of the following: a biometric parameter, a password, a passcode, multi-factor authentication, or any combination thereof.

11. The computer program product of claim 8, wherein updating at least one feature associated with at least one user account comprises canceling the at least one user account.

12. The computer program product of claim 8, wherein updating at least one feature associated with at least one user account comprises assigning a new account identifier to the at least one user account.

13. The computer program product of claim 8, wherein updating at least one feature associated with at least one user account comprises adding or removing a temporary account hold.

14. The computer program product of claim 8, wherein updating at least one feature associated with at least one user account comprises confirming or denying the authenticity of a transaction conducted using the at least one user account.

15. A system comprising:
a. one or more hardware processors; and
b. a storage device storing instructions that, when executed by the one or more hardware processors, causes the one or more hardware processors to perform operations comprising:
i. receiving, with at least one processor, input from a user of at least one user resource, the input indicating the occurrence of an event;
ii. generating and communicating, utilizing a graphical user interface, with at least one processor, at least one notification to the user, the at least one notification comprising at least one option associated with the event;
iii. receiving, from the at least one user resource and user resource, with at least one processor, a user reply to the at least one notification, the user reply comprising; (i) confirmation of a request to update at least one feature associated with at least one user account associated with the user; or (ii) denial of the request to update at least one feature associated with at least one user account associated with the user;
iv. in response to receiving the user reply to the at least one notification comprising confirmation of the request to update at least one feature associated with the at least one user account, automatically constructing, with at least one processor, at least one application program interface (API) request comprising the user reply and information associated with the event;
v. transmitting, with at least one processor, the API request to the server of a service provider; and
vi. in response to the transmitting, receiving, at the at least one user resource, with at least one processor, at least one message from the server of the service provider, the at least one message comprising confirmation that the at least one feature associated with the at least one user account has been updated.

16. The system of claim 15, wherein, in response to receiving the user reply to the at least one notification comprising denial of the request to update at least one feature associated with the at least one user account, automatically storing the user reply and information associated with the event.

17. The system of claim 15, wherein the user reply to the at least one notification comprises at least one of the following: a biometric parameter, a password, a passcode, multi-factor authentication, or any combination thereof.

18. The system of claim 15, wherein updating at least one feature associated with at least one user account comprises canceling the at least one user account.

19. The system of claim 15, wherein updating at least one feature associated with at least one user account comprises assigning a new account identifier to the at least one user account.

20. The system of claim 15, wherein updating at least one feature associated with at least one user account comprises adding or removing a temporary account hold.
